(19) United States
(12) Patent Application Publication
(10) Pub. No.: US 2010/0072726 A1
(43) Pub. Date: Mar. 25, 2010

(54) Systems and Methods for Providing a Bicycle with Large Load Carrying Capacity

(76) Inventor: Jared Madsen, Salt Lake City, UT (US)

Correspondence Address: S. Brandon Owen;Ray Quinney & Nebeker P.C., 36 South State Street, Suite 1400, Salt Lake City, UT, 84111, US

(21) Appl. No.: 12/564,503

(22) Filed: Sep. 22, 2009

Related U.S. Application Data
(60) Provisional application No. 61/099,133, filed on Sep. 22, 2008.

(51) Int. Cl. B62K 7/04; B62J 7/04; B62H 1/04; B62J 9/00

(52) U.S. Cl. 280/202; 280/281.1; 280/302; 224/433

(57) ABSTRACT

A bicycle offering a stable ride, yet capable of supporting loads of 600 pounds (or more). Features and various implementations of the present invention include: (1) a frame having a low center of gravity with respect to the load; (2) a wide-stance heavy-duty double kick-stand; (3) support for a rigid hard cargo compartment that does not crush goods; (4) a frame that is strong and durable, yet easy for any metal shop to fix; and (5) an additional support surface for an extra seat, a cooler flat bed, a space case, a bicycle rack, a storage container, an additional rack expansion, or rack carrying devices to carry any needed item.

### PRIORITY STATEMENT

The present application claims priority to U.S. Provisional Application No. 61/099,133, filed Sep. 22, 2008 entitled Systems and Methods for Providing a Bicycle with Large Load Carrying Capacity.

### BACKGROUND OF THE INVENTION

1. Field of the Invention

The present invention relates to a bicycle that supports loads of 600 pounds or more, yet retains the ability to provide a stable ride. In particular, the present invention relates to a bicycle with a frame that has a low center of gravity with respect to the load, as well as offers the following features: (1) a double-duty kick-stand with a wide stance; (2) a support for a rigid hard cargo compartment that does not crush goods; (3) a frame that is strong and durable, yet easy for any metal shop to fix; and (4) other additional supports for an extra seat, a cooler, flat bed, a space case, a bicycle rack or a storage container.

2. Background and Related Art

Citing environmental concerns and noting an increasing popularity of the sport, many claim bicycling is an efficient, enjoyable and environmentally-sound way to travel and transport. In fact, bicycling in many cultures is the main mode of transportation, and people rely on it to not only get around, but also, to transport cargo. With respect to the latter, couriers in many areas of the world claim bicycling is the most cost-effective and quick way to deliver cargo or packages. Even police navigate urban areas on a bicycle, implicating its ease and efficiency.

Thus, bicycle enthusiasts and bicycling industry experts are seeking novel and unique ways to enjoy the sports' many advantages; and new and improved bicycles are desired that enable a rider to enjoy a smooth ride while simultaneously safely and securely delivering cargo.

Many tricycles are used to transport loads, but they have drawbacks. They do not ride as smoothly as a bicycle and are designed to be operated at a low speed. Cornering on a tricycle is only safely performed at a low speed. A tricycle can tip during cornering maneuvers. Additionally, a tricycle can require a complicated differential due to two rear wheels being parallel to one another.

It is important to note that in the prior art, if a bicycle was used for transport, large cargo was carried on the front, and if on the back, the passenger was no longer able to ride on it efficiently and smoothly, if at all.

Thus, while presently available bicycles are used to transport and carry loads or passengers, many challenges still exist. Accordingly, it would be an improvement in the art to provide or even replace current bicycles with bicycles having improved transport features.

### SUMMARY OF THE INVENTION

Implementation of the present invention relates to a bicycle offering a stable ride, yet capable of supporting loads up to 600 pounds (or more). Features and implementations of various implementations of the present invention include: (1) a frame having a low center of gravity with respect to the load; (2) a wide-stance heavy-duty double kick-stand; (3) support for a rigid hard cargo compartment that does not crush goods; (4) a frame that is strong and durable, yet easy for any metal shop to fix; and (5) an additional support surface for an extra seat or seats, a cooler flat bed, a space case, a bicycle rack or a storage container.

A kick-stand mounts to the frame without any visible friction points. The kick-stand also has a wide stance preventing the bicycle from tipping. Moreover, the pivot points of the kickstand are relatively far apart, further adding strength and stability. Finally, the kickstand locks, in the up and down position, by a two-spring mechanism.

A cargo container mounts on a bucket mount that replaces a typical rack. In one implementation, the mount is a single bar that runs parallel to the frame. Though cargo contained within the cargo container may weigh as much as 400 pounds or more, in addition to the weight of the operator, the bicycle still provides a smooth ride.

In at least some implementations, the rear wheel is smaller than the front wheel, which lowers the center of gravity of the load being carried. This further provides a smooth and controlling ride.

In some implementations, the seat attachments are configured so that the seats mount side saddle.

While the methods and processes of the present invention are particularly useful in the area of bicycle cargo carriers, those skilled in the art can appreciate that the methods and processes can be used in a variety of different bicycle applications.

These and other features and advantages of the present invention are set forth or are more fully apparent in the description that follows and in the appended claims and drawings. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order for the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, considered as limiting the scope of the invention, the present invention will be described and explained with additional specificity and detail through the use of the accompanying drawings in which:

FIG. 1 illustrates a representative embodiment of the present invention with a cargo-carrying container;

FIG. 2 illustrates a representative embodiment of the present invention sans the cargo-carrying component;

FIG. 3 illustrates a representative embodiment of the present invention with various components separated apart from one another;

FIG. 4 illustrates a representative frame and rack;

FIG. 5 illustrates a representative kick stand; and

FIG. 6 illustrates a close-up view of a representative kick-stand.

### DETAILED DESCRIPTION OF THE INVENTION

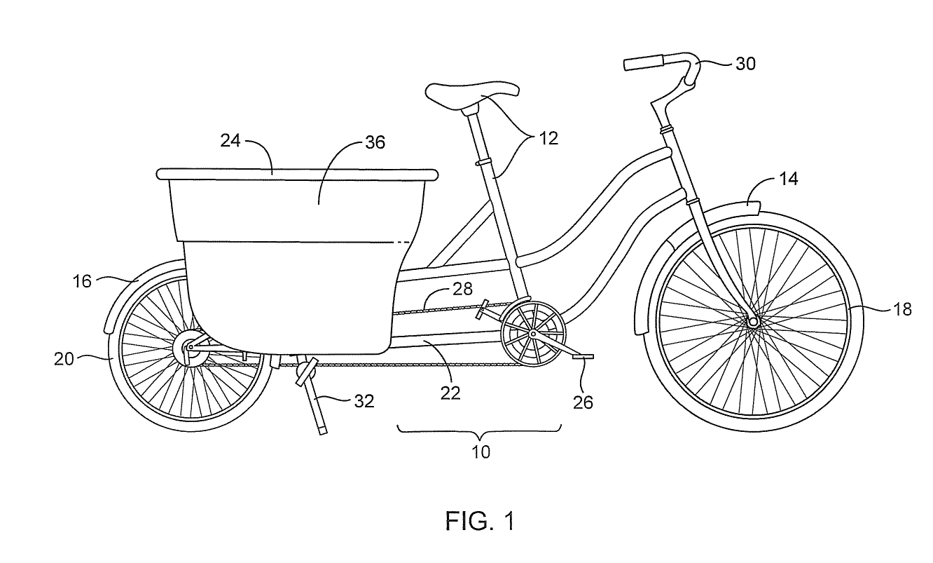

The present invention relates to a large load carrying bicycle. FIG. 1 and the corresponding discussion are intended to provide a general description of one exemplary embodiment in which the invention may be configured and implemented. One skilled in the art, though, will appreciate that the invention may be embodied by a variety of configurations.

Specifically, in FIG. 1, a representation of the present invention is provided. In detail, a bicycle frame 10 having a seat receiving member 12, a front wheel receiving member 14 and a back wheel receiving member 16 is illustrated. The seat receiving member 12 is to receive and support the bicyclist. The front wheel 18 is larger than a back wheel 20, which gives the bicycle 10 a low center of gravity with respect to the load it may carry, so that though the load may be large, the bicycle 10 retains its ability to ride smoothly. Moreover, at least one support member 22 is coupled to the front wheel receiving member 14, the back wheel receiving member 16 and to the seat receiving member 12. The frame 10 is also elongated between the seat receiving member 12 and the back wheel receiving member 16, further fostering a smooth ride notwithstanding a large load.

FIG. 1 also illustrates a cargo container 24 for the transportation of cargo weighing approximately 400 pounds. Those skilled in the art will appreciate that embodiments of the present invention embrace cargo containers that can hold more or less than 400 pounds.

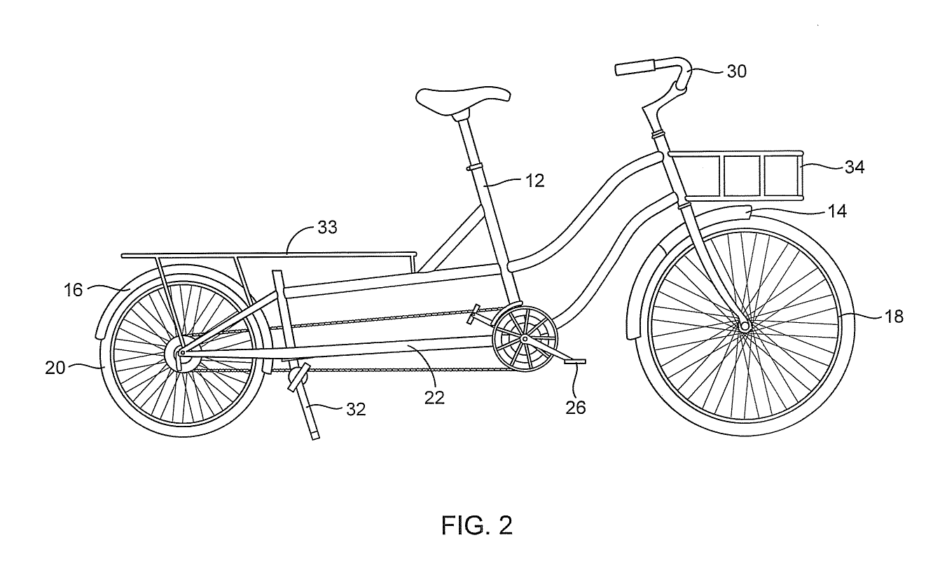

The bicycle has components such as pedals 26, chains 28, handlebars 30, and the like. It also has the capacity to retain an additional support 34 (see FIG. 2) for the carrying of extra cargo.

A stand 32 is “U-shaped.” However, it is configured similar to a wide “U.” That is, the base of the stand 32 is wide relative to the sides that touch down on the ground. The stand 32 may also comprise other shapes providing similar stability features. The stand locks in an up-right position, (i.e., in the position where the bicycle is ready to go, which may be any position allowing the bicycle to move), and in the down (stationary) position by a spring assembly. In one embodiment, the stand 32 mounts to the frame 10 like a post that attaches to a bicycle frame but it is inverted. A stand mount 35 (not shown) causes the stand to be adjustable. Additionally, the mount provides increased strength.

The cargo container 24 has two side walls 36 and a frame receiving channel 38 for receiving within it, the frame 10 of the bicycle. The cargo container 24 can be made from a rigid material or other suitable material capable of carrying a large load.

In FIG. 2, the present invention is depicted without the cargo container 24, and instead, a cargo receiving member 33 is exposed. This is the surface that receives the cargo container 24. Also in this figure, the additional support 34 is depicted. This surface can be for supporting an extra seat, a cooler, a flat bed, a space case, a bicycle rack, a storage container, or the like.

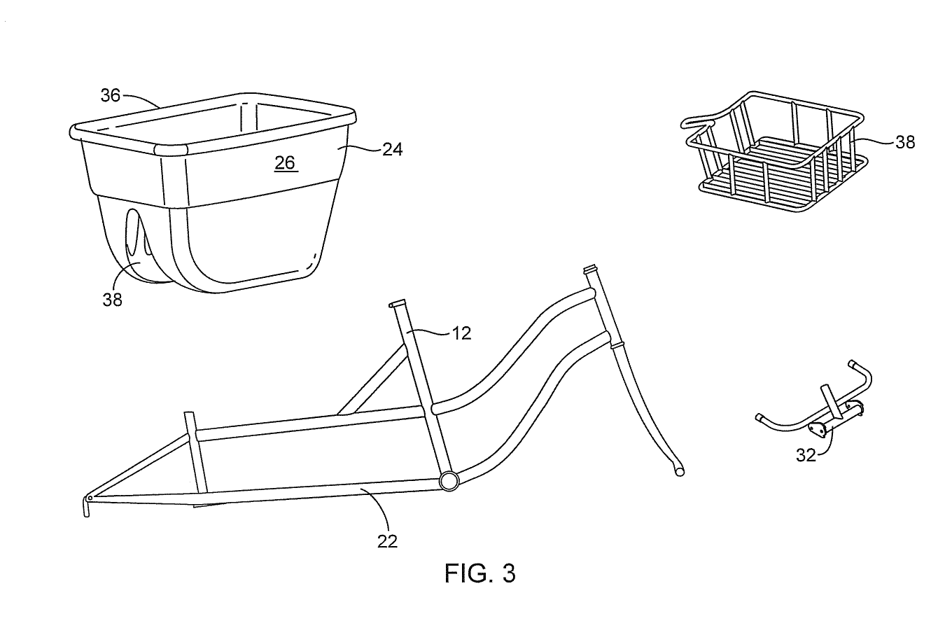

FIG. 3 represents components of the present invention as they are separate and apart from each other. Specifically, FIG. 3 depicts the rigid cargo compartment having two side walls 36, the frame receiving channel 38, which fits over the frame 10 to support and carry the cargo. A front basket 38 is depicted, which can be an exemplary, but not limiting, type of container that may be supported by additional support 34. FIG. 3 also illustrates the heavy duty kickstand 32 with wide-stance in an upright position, i.e., the non-stationary position for the bicycle.

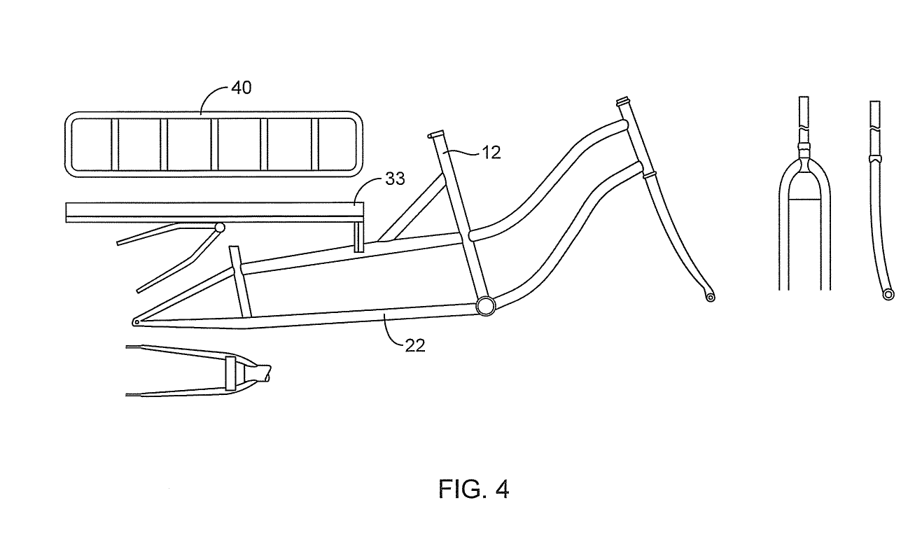

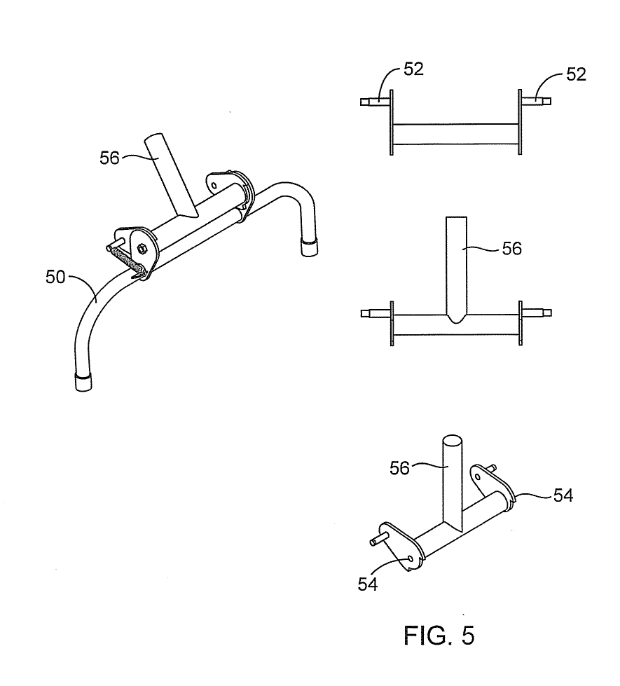

FIGS. 4 and 5 illustrate the frame 10 with a rack 40 and kickstand 32, respectively, with exemplary, but not limiting, dimensions. In FIG. 4, the cargo receiving member 33 receives the rack 40, which may carry cargo loads. FIG. 5 shows components of an exemplary kickstand 32 that include a “U” shaped stand 50, two spring mounts 52, pivot points 54, and a mounting post 56.

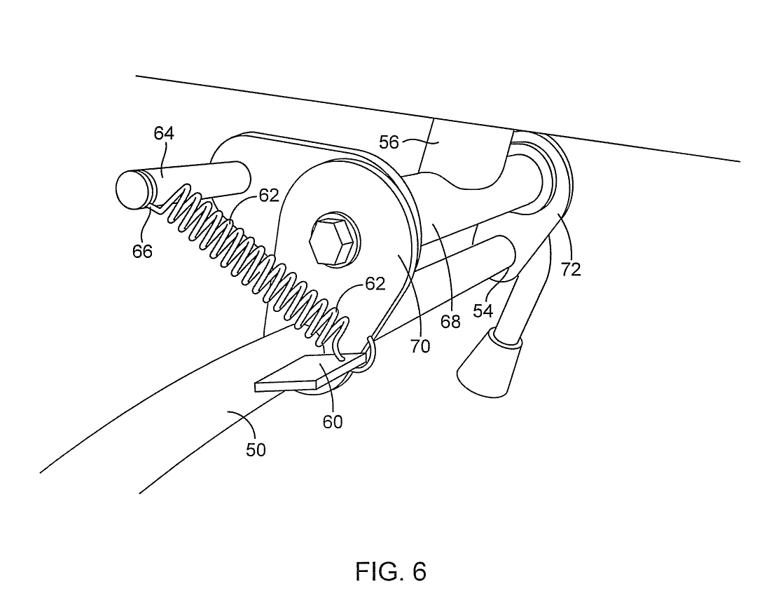

FIG. 6 shows the “U” shaped stand 50 with a first spring mount 60 coupled to a first end of a spring 62 and a second spring mount 64 coupled to a second end of a spring 66. FIG. 6 also shows pivot point 54 and mounting post 56. In addition, FIG. 6 shows stabilizing bar 68, first support plate 70 and second support plate 72, where the stabilizing bar 68 is connected to both the first support plate 70 and the second support plate 72 and where the “U” shaped stand 50 is pivotably connected to both the first support plate 70 and the second support plate 72. Those skilled in the art will appreciate that the dimensions provided herein are representative only, and that embodiments of the present invention embrace dimensions that are larger or smaller than those represented.

Other general embodiments and applications for the present invention include the cargo container 24 with two side saddle seats. Other embodiments also allow for live passengers in the cargo container.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A bicycle frame comprising:
a seat receiving member;
a front wheel receiving member;
a back wheel receiving member, wherein the front wheel is larger than the back wheel; and
a plurality of support members coupling the front wheel receiving member, the back wheel receiving member and the seat receiving member, wherein the frame is elongated between the seat receiving member and the back wheel receiving member, and wherein the plurality of support members include a plurality of substantially parallel horizontal support members.

2. A bicycle frame as in claim 1, further comprising an additional support member for providing for at least one of an extra seat, a cooler, a flat bed, a space case, a bicycle rack or a storage container.

3. A bicycle comprising:
a seat, selectively coupled to a frame;
a front wheel, selectively coupled to the frame;
a back wheel, selectively coupled to the frame wherein the front wheel is larger than the back wheel; and
an elongated portion between the seat and the back wheel, the elongated portion coupled to a cargo container.

4. The bicycle of claim 3, further comprising a bicycle stand coupled to the elongated portion between the seat and the back wheel, the bicycle stand comprising:
a U-shaped member having two sides and an elongated bar therebetween.

5. A container comprising:
a rim;
a plurality of side walls coupled to the rim; and
a frame receiving channel extending between the plurality of side walls for selective coupling to an elongated bicycle frame between a seat receiving member and a back wheel receiving member of the frame.

6. A bicycle stand comprising:
a U-shaped member having two sides and an elongated bar therebetween,
a pivotal connection member centrally connected to the elongated bar to form a pivotal connection, wherein the pivotal connection member connects to a frame of a bicycle, such that when the bicycle is stationary, the sides of the elongated bar are in contact with the ground, and when the bicycle is in motion, the two sides are proximal to the frame of the bicycle.
